(19) United States
(12) Patent Application Publication
(10) Pub. No.: US 2023/0289766 A1
(43) Pub. Date: Sep. 14, 2023

(54) ORDERING SYSTEM, CONTROL APPARATUS, TABLET, CONTROL METHOD, AND NON-TRANSITORY COMPUTER-READABLE MEDIUM

(71) Applicant: NEC Platforms, Ltd, Kanagawa (JP)

(72) Inventors: Yuta YAMAWAKI, Kanagawa (JP); Yusuke HOSODA, Kanagawa (JP); Masaya KOMAKI, Kanagawa (JP); Tatsuya OTSUKA, Kanagawa (JP)

(73) Assignee: NEC Platforms, Ltd, Kanagawa (JP)

(21) Appl. No.: 18/017,026

(22) PCT Filed: May 21, 2021
(86) PCT No.: PCT/JP2021/019387

§ 371 Date: Jan. 19, 2023

(30) Foreign Application Priority Data
Jul. 29, 2020 (JP) 2020-128030

(51) Int. Cl. G06Q 20/20

(52) U.S. Cl. CPC G06Q 20/209; G06K 15/024

(57) ABSTRACT

An ordering system (100) according to the present disclosure includes: a tablet (10) configured to accept input of customer-identification-by-display information that is used to identify a customer through display thereof; and a control apparatus (20) configured to associate the customer-identification-by-display information that has been input in the tablet (10) with a product ordered by the customer to thereby acquire the associated information as order information. The control apparatus (20) generates printing information for printing the customer-identification-by-display information on a label and outputs the generated printing information to a printer, and generates display information for checkout processing for showing the order information to a user who is performing a checkout operation for the product ordered by the customer and outputs the generated display information to a display device for checkout processing.

### TECHNICAL FIELD

The present disclosure relates to an ordering system, a control apparatus, a tablet, a control method, and a control program.

### BACKGROUND ART

In recent years, coffee shops and the like have served a wide variety of beverages to customers in paper cups or plastic cups. Store staff may hand-write information as appropriate on these containers to ensure that the products ordered by customers are provided to the respective customers who placed the orders without making any mistake in the order details. The information items to be written on each of these containers include the name of the product, the size of the product, the customization details of the product, the name of the customer who ordered the product, and the like.

For example, Patent Literature 1 discloses a technique in which in the case where a customer's order at a hamburger store includes a request for customization, a sticker on which the details of the request for customization is printed is issued. A request for customization refers to an order in which a request is made for changes to the contents of a regular product, for example, “no pickles”, “extra mayonnaise”, etc.

### CITATION LIST

### Patent Literature

Patent Literature 1: Japanese Unexamined Patent Application Publication No. 2014-206953

### SUMMARY OF INVENTION

### Technical Problem

Store staff are required to provide products including customized products like those described in Patent Literature 1 to customers who ordered the respective products without making any mistakes in the order details. To achieve this, store staff write the information items on the containers as described above, but in the case where too many orders are placed at the same time or when orders for similar products are placed at the same time, there is a risk of handing over products to customers different from those who ordered the products. Store staff always have to try to be careful to avoid making such mistakes when providing the ordered products, which puts a burden on the store staff. This issue is not taken into account in the technique disclosed in Patent Literature 1.

The present disclosure has been made in view of the problem mentioned above, and an object of the present disclosure is to provide an ordering system, a control apparatus, a tablet, a control method, and a control program which are adapted to reduce the burden on store staff when they are providing the products ordered by customers.

### Solution to Problem

An ordering system according to the present disclosure includes:
a tablet configured to accept input of customer-identification-by-display information that is used to identify a customer through display thereof; and
a control apparatus configured to associate the customer-identification-by-display information that has been input in the tablet with a product ordered by the customer to thereby acquire the associated information as order information,
in which the control apparatus
   generates printing information for printing the customer-identification-by-display information on a label and outputs the generated printing information to a printer, and
   generates display information for checkout processing for showing the order information to a user who is performing a checkout operation for the product ordered by the customer and outputs the generated display information to a display device for checkout processing.

An ordering system according to the present disclosure includes:
a store server configured to store customer identification information for identifying a customer and customer-identification-by-display information that is used to identify the customer through display thereof in association with each other;
a reader for reading the customer identification information from a medium shown by the customer; and
a control apparatus configured to acquire the customer-identification-by-display information associated with the customer identification information read by the reader and associate the acquired customer-identification-by-display information with a product ordered by the customer, to thereby acquire the associated information as order information,
in which the control apparatus
   generates printing information for printing the customer-identification-by-display information on a label and outputs the generated printing information to a printer, and
   generates display information for checkout processing for showing the order information to a user who is performing a checkout operation for the product ordered by the customer and outputs the generated display information to a display device for checkout processing.

A control apparatus according to the present disclosure includes:
acquisition means for acquiring information obtained by associating customer-identification-by-display information that has been input in a tablet configured to accept input of the customer-identification-by-display information that is used to identify a customer through display thereof with a product ordered by the customer as order information;
output means for generating printing information for printing the customer-identification-by-display information on a label and outputting the generated printing information to a printer; and
output means for generating display information for checkout processing for showing the order information to a user who is performing a checkout operation for the product ordered by the customer and outputting the generated display information to a display device for checkout processing.

A tablet according to the present disclosure includes:
display means for displaying an input screen prompting input of customer-identification-by-display information to be printed on a label affixed to a product ordered by a customer;
acquisition means for acquiring the customer-identification-by-display information that has been input in the input screen; and
output means for outputting the acquired customer-identification-by-display information to a control apparatus.

A control method according to the present disclosure includes steps of:
acquiring information obtained by associating customer-identification-by-display information that has been input in a tablet configured to accept input of the customer-identification-by-display information that is used to identify a customer through display thereof with a product ordered by the customer as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

A control program according to the present disclosure causes a computer to execute a control method comprising steps of:
acquiring information obtained by associating customer-identification-by-display information that has been input in a tablet configured to accept input of the customer-identification-by-display information that is used to identify a customer through display thereof with a product ordered by the customer as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

### Advantageous Effects of Invention

According to the present disclosure, it is possible to provide an ordering system, a control apparatus, a tablet, a control method, and a control program which are adapted to reduce the burden on the store staff when they are providing the products ordered by customers.

### BRIEF DESCRIPTION OF THE DRAWINGS

FIG. 1 is a block diagram showing a configuration of an ordering system according to a first example embodiment;

FIG. 2 is a block diagram showing a configuration of an ordering system according to a second example embodiment;

FIG. 3 is a flowchart showing processing performed by a POS terminal according to the second example embodiment;

FIG. 4 is a diagram showing an example of information displayed on a display device for checkout processing according to the second example embodiment;

FIG. 5 is a diagram showing an example of information displayed on a display device for kitchen-use according to the second example embodiment;

FIG. 6 is a block diagram showing a configuration of an ordering system according to a third example embodiment;

FIG. 7 is a block diagram showing a configuration of an ordering system according to a fourth example embodiment;

FIG. 8 is a flowchart showing processing performed by a POS terminal according to the fourth example embodiment;

FIG. 9 is a diagram showing an example of information displayed on a display device for checkout processing according to the fourth example embodiment; and

FIG. 10 is a block diagram showing an example of a hardware configuration.

### DESCRIPTION OF EXAMPLE EMBODIMENT

### First Example Embodiment

Hereinbelow, example embodiments of the present disclosure will be described with reference to the drawings.

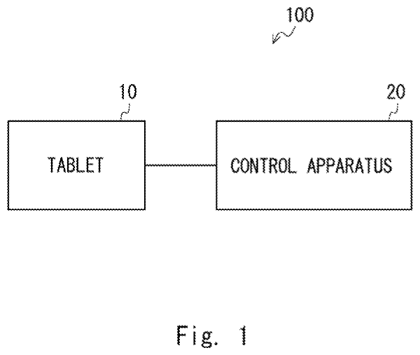

FIG. 1 is a block diagram showing a configuration of an ordering system 100 according to this example embodiment. As shown in FIG. 1, the ordering system 100 includes a tablet 10 and a control apparatus 20.

The tablet 10 accepts input of customer-identification-by-display information that is used to identify a customer through display thereof.

The control apparatus 20 associates the product ordered by a customer with the customer-identification-by-display information that has been input in the tablet 10 to thereby acquire the associated information as order information.

Further, the control apparatus 20 generates printing information for printing the customer-identification-by-display information on a label and outputs the generated printing information to a printer.

Further, the control apparatus 20 generates display information for checkout processing showing the order information to the user who is performing the checkout operation for the product ordered by a customer and outputs the generated display information to the display device for checkout processing.

As described above, in the ordering system 100 according to this example embodiment, the customer-identification-by-display information that has been input in the tablet 10 can be printed on a label, and the label can be affixed to the product ordered by a customer. Further, since the order information including the customer-identification-by-display information can be displayed on the display device for checkout processing, the user (store staff) who performs the checkout operation for a product ordered by a customer can provide the ordered product to the customer after confirming the information displayed on the display device for checkout processing and the label affixed to the beverage container of the ordered product. Accordingly, it is possible to reduce the burden on the store staff when they are providing the products ordered by customers.

### Second Example Embodiment

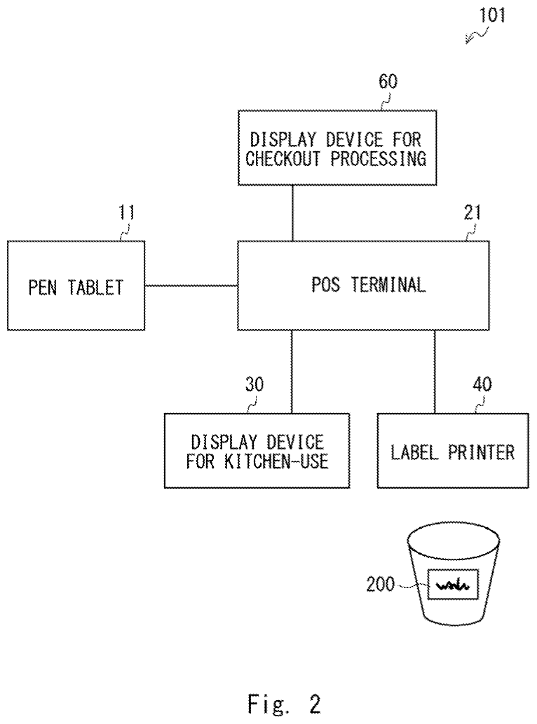

Next, a second example embodiment of the present disclosure will be described with reference to FIGS. 2 to 5. In the second example embodiment, the ordering system 100 described in the first example embodiment will be described in detail.

First, a configuration of an ordering system 101 according to this example embodiment will be described with reference to FIG. 2. FIG. 2 is a block diagram showing a configuration of the ordering system 101. As shown in FIG. 2, the ordering system 101 includes a pen tablet 11, a POS (Point Of Sales) terminal 21, a label printer 40, a display device for kitchen-use 30, and a display device for checkout processing 60.

The pen tablet 11 is a tablet for accepting input of customer-identification-by-display information 200 that is used to identify a customer through display thereof. The pen tablet 11 displays an input screen prompting input of the customer-identification-by-display information 200 to be printed on a label affixed to a product ordered by a customer. The pen tablet 11 acquires the customer-identification-by-display information 200 that has been input through the input screen and outputs the acquired customer-identification-by-display information 200 to the POS terminal 21. The customer-identification-by-display information 200 includes, for example, signatures and graphic written by customers. The customer-identification-by-display information 200 is printed on a label using the label printer 40 and then the label is affixed to a product ordered by a customer. A product ordered by a customer includes a wrapping of the product, and an example thereof is a paper cup with coffee in it.

The pen tablet 11 has a board-type tablet main body and an electronic pen, and a customer enters his/her signature and other information in the display device by sliding the electronic pen on the display device provided to the tablet main body. When a customer slides the electronic pen on the display device, the pen tablet 11 detects what has been input in the display device by reading the position of the electronic pen using a built-in sensor of the tablet main body. In this way, the pen tablet 11 accepts the tracking information of touch input performed by the customer, as the customer-identification-by-display information 200. The customer-identification-by-display information 200 is not limited to text, and may be any content such as graphics or illustrations. Further, the customer-identification-by-display information 200 is not limited to freehand input and may be one or more characters or images selected by a customer from those displayed on the display device. Various methods such as an infrared light blocking method, a capacitance method, a resistive film method, and an electromagnetic induction method may be used for detection of the information input in the pen tablet 11. Further, a customer may use his/her own finger to sign, select images, and the like instead of using an electronic pen. It is desirable that the pen tablet 11 be installed at a location where customers can operate it at the time of placing their orders, for example, near the POS terminal 21.

The checkout processing for a product ordered by a customer is performed through the POS terminal 21. The POS terminal 21 is connected to the pen tablet 11, the label printer 40, the display device for kitchen-use 30, and the display device for checkout processing 60, respectively, through cables or wirelessly in a communicable manner. The POS terminal 21 functions as a control apparatus for associating the product ordered by a customer with the customer-identification-by-display information 200 input in the pen tablet 11 and acquiring the associated information as order information. Further, the POS terminal 21 generates printing information for printing the customer-identification-by-display information 200 on a label and outputs the generated printing information to the label printer 40. Further, the POS terminal 21 generates the display information for checkout processing, the information being used for displaying the order information to the store staff who is performing the checkout operation for the product ordered by a customer, and outputs the generated display information to the display device for checkout processing 60. In the generation of the display information for checkout processing, the POS terminal 21 can associate the status information indicating the status of provision of the product ordered by a customer with the order information to thereby generate the display information for checkout processing. Then, the POS terminal 21 generates display information for kitchen-use for displaying the order information in the kitchen and outputs the generated display information on the display device for kitchen-use 30. Like in the generation of the display information for checkout processing, the POS terminal 21 may associate the status information indicating the status of provision of the product ordered by a customer with the order information to thereby generate the display information for kitchen-use in the generation of the display information for kitchen-use.

The label printer 40 prints out labels that are affixable to paper cups, plastic cups, and the like. As shown in the example shown in FIG. 2, the customer-identification-by-display information 200 is printed on a label. The size of the label should be large enough to ensure easily visibility of the contents of the information printed on the label for the store staff and the customers. The label printer 40 is installed in the kitchen.

The display device for kitchen-use 30 is a display device connected to a kitchen terminal (not shown) for acquiring the order information acquired through the POS terminal 21. The display device for kitchen-use 30 associates the product ordered by a customer with the customer-identification-by-display information 200 input in the pen tablet 11 and displays the associated information. The display device for kitchen-use 30 is installed in the kitchen. The store staff who cooks in the kitchen can confirm the details of an order received from a customer by visually confirming the contents of information displayed on the display device for kitchen-use 30.

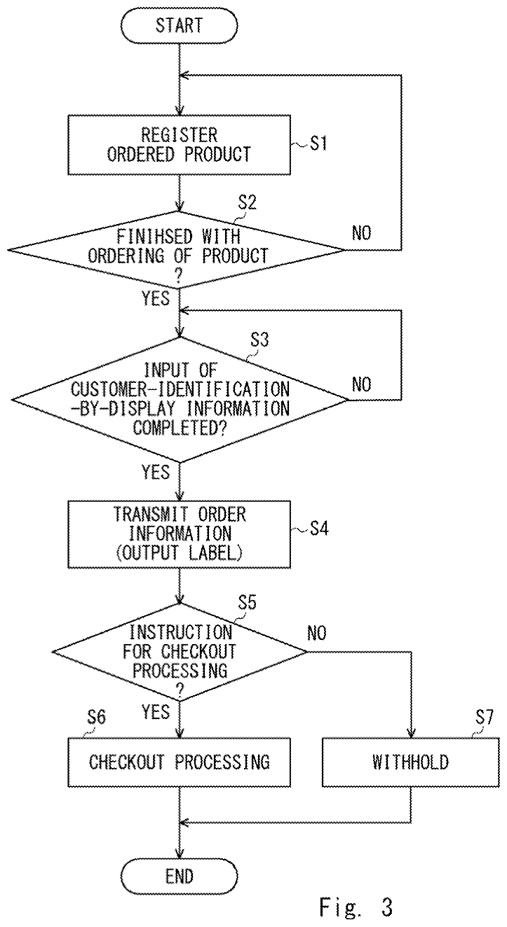

Next, the processing performed by the POS terminal 21 will be described with reference to FIG. 3. FIG. 3 is a flowchart showing processing performed by the POS terminal 21.

First, when a new order is placed by a customer, the POS terminal 21 registers the product ordered by a customer (Step S1). The POS terminal 21 determines whether or not there has been entry of product order completion (Step S2) and in the case where the product order completion has been entered (YES in Step S2), performs the processing of Step S3. In the case where the product order completion has not been entered (NO in Step S2), the POS terminal 21 returns to Step S1 and repeats the processing of Step S1.

Next, the POS terminal 21 determines whether or not input of the customer-identification-by-display information 200 (signatures and graphics) in the pen tablet 11 has been completed (Step S3). Specifically, for example, the pen tablet 11 displays an “input complete” button at the top of the screen of the pen tablet 11 and the customer clicks the button with an electronic pen to thereby let the pen tablet 11 recognize that the input of the customer-identifying information 200 has been completed. When there is an input indicating that the input of the customer-identifying information 200 has been completed (YES in Step S3), the POS terminal 21 performs the processing of Step S4. When there is no input indicating that the input of the customer-identifying information 200 has been completed (NO in Step S3), the POS terminal 21 repeats the processing of Step S3. The store staff prompts the customer to enter the customer-identification-by-display information 200 using the pen tablet 11 and the customer performs the input operation.

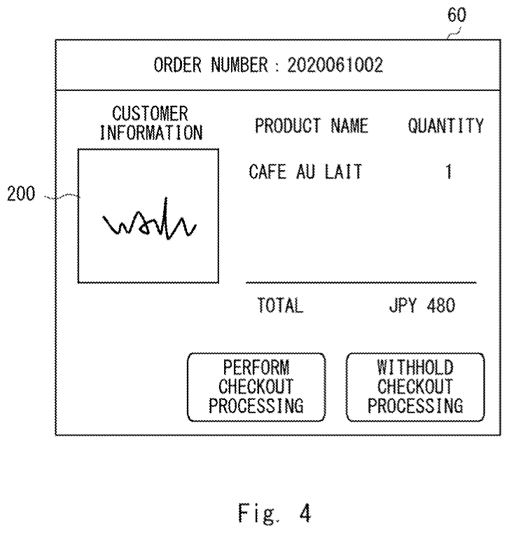

FIG. 4 is a diagram showing an example of information displayed on the display device for checkout processing 60 of the POS terminal 21 after input of the customer-identification-by-display information 200 has been completed. As shown in FIG. 4, the order number, the product ordered by a customer, and a signature which is the customer-identification-by-display information 200 are displayed on the display device for checkout processing 60. These displayed information are also displayed on the display device for customer use (not shown) installed to the POS terminal 21 except for information that is not necessary for the customer such as the checkout button. The POS terminal 21 stores the order number, the product ordered by a customer, and the customer-identification-by-display information 200 as order information.

The POS terminal 21 sends the order information to the display device for kitchen-use 30 and causes the label printer 40 to output a label on which the customer-identification-by-display information 200 is printed and then performs the processing of Step S5 (Step S4). The display device for kitchen-use 30 displays, like the display device for checkout processing 60 shown in FIG. 4, the order information including the customer-identification-by-display information 200. A store staff in the kitchen confirms the information displayed on the display device for kitchen-use 30, pours the beverage which is the product ordered by a customer into a beverage container (such as a paper cup, a plastic cup, etc.) and affixes the label on which the customer-identification-by-display information 200 is printed to the beverage container.

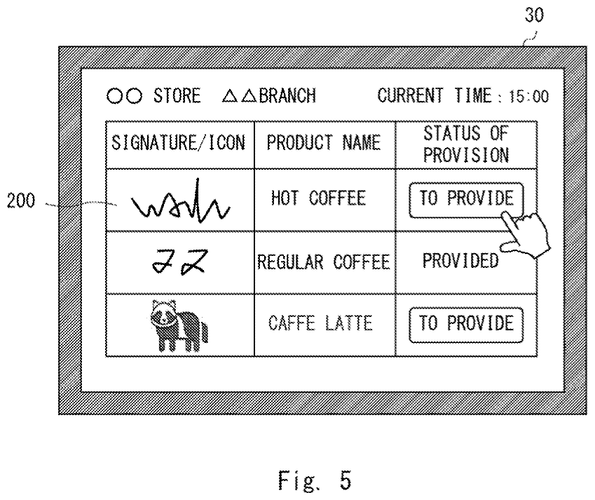

Information displayed on the display device for kitchen-use 30 is not limited to information for one order like the aforementioned order. For example, as shown in FIG. 5, information may be displayed for a plurality of orders. In the example shown in FIG. 5, the POS terminal 21 associates the status information indicating the status of provision of the product ordered by a customer with the order information to thereby generate the display information for kitchen-use. By displaying a plurality of orders in a form of a list on the display device for kitchen-use 30 as described above, store staff can visually confirm the status of provision of the products ordered by a plurality of customers to the respective customers who ordered the products.

Next, the POS terminal 21 determines whether or not there has been an input instructing to proceed to checkout processing for the product ordered by a customer (Step S5). For example, the POS terminal 21 determines whether or not there has been an instruction to proceed to checkout processing by store staff pressing the “checkout processing” button shown in FIG. 4. In the case an instruction to perform checkout processing for the product ordered by a customer is input (YES in Step S5), the POS terminal 21 performs the processing of Step S6. In the case where an instruction to perform checkout processing for the product ordered by a customer has not been input, that is, in the case where there has been an input to withhold the checkout processing (NO in Step S5), the POS terminal 21 performs the processing of Step S7. In the case where it takes time to provide the product ordered by a customer, the store staff presses a “withhold checkout processing” button and the checkout processing for the product ordered by a customer is withheld.

In the case of performing the checkout processing for the product ordered by a customer (YES in Step S5), the POS terminal 21 performs the necessary checkout processing (Step S6) and the processing ends. At this time, the store staff visually confirms the information displayed on the display device for checkout processing 60 and confirms the label affixed to a beverage container, and then provides the product ordered by a customer to the customer who ordered the product. The customer confirms that the provided product is the one he/she ordered by checking the label on the beverage container and then receives the product. Note that the POS terminal 21 may associate the status information indicating the status of provision of the product ordered by a customer with the order information to thereby generate the display information for checkout processing and then output the generated display information to the display device for checkout processing 60. By this configuration, it is possible to display a list like the one shown in FIG. 5 on the display device for checkout processing 60 and the store staff can visually confirm the status of provision of the products ordered by a plurality of customers to the respective customers who ordered the products. Further, by displaying the status of provision of the product ordered by a customer along with the completion status of checkout processing, it is possible to perform checkout processing error-free.

In the case of withholding the checkout processing for the product ordered by a customer (NO in Step S5), the POS terminal 21 does not perform the checkout processing (Step S7) and the processing ends. The order information for which checkout processing has been withheld is called up by store staff upon completion of preparation of the product ordered by a customer. Then, the POS terminal 21 performs the checkout processing (Step S6) and the processing ends.

As described above, in the ordering system 101 according to this example embodiment, store staff can provide products ordered by customers to the respective customers who ordered the products by confirming the information displayed on the display device for checkout processing 60 and the labels affixed to the beverage containers of the products ordered by customers. The customer-identification-by-display information 200 is shown on the display device for checkout processing 60 and the labels affixed to the products, thus reducing the burden on the store staff who are providing the products ordered by customers. Further, the customer can make sure that the provided product is the one which he/she ordered by confirming the label affixed to the beverage container, and so the customer can receive the ordered product without making any mistake of product mix-up. Further, since there is no need to use the names and the like of the customers for the customer-identification-by-display information 200, there is no risk of customers' personal information being seen by a third party. Therefore, it is possible to easily link information about the customers and their ordered products while respecting privacy of the customers.

### Third Example Embodiment

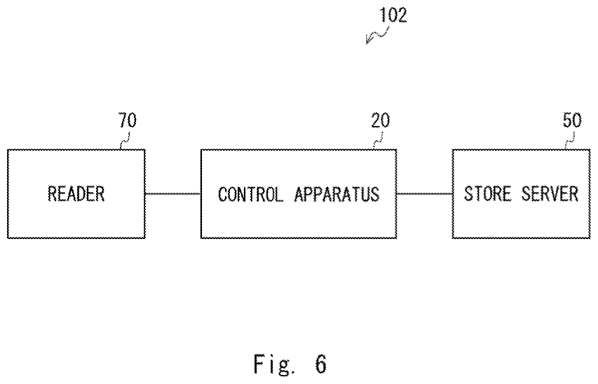

Next, an ordering system 102 according to this example embodiment will be described with reference to FIG. 6. FIG. 6 is a block diagram showing a configuration of the ordering system 102.

As shown in FIG. 6, the ordering system 102 includes a store server 50, a reader 70, and a control apparatus 20.

The store server 50 stores the customer identification information for identifying a customer and the customer-identification-by-display information that is used to identify the customer through display thereof in association with each other.

The reader 70 reads the customer identification information from a medium presented by a customer.

The control apparatus 20 acquires, from the store server 50, the customer-identification-by-display information associated with the customer identification information read by the reader 70 and associates the acquired customer-identification-by-display information with the product ordered by a customer, to thereby acquire the associated information as order information.

Further, the control apparatus 20 generates printing information for printing the customer-identification-by-display information on a label and outputs the generated printing information to a printer.

Further, the control apparatus 20 generates the display information for checkout processing for showing the order information to the store staff who is performing the checkout operation for the product ordered by a customer and outputs the generated display information to the display device for checkout processing.

As described above, in the ordering system 102 according to this example embodiment, the customer-identification-by-display information stored in the store server 50 can be acquired by reading the customer identification information from a medium shown by a customer using the reader 70. Further, the label on which the acquired customer-identification-by-display information is printed can be printed and affixed to a product ordered by a customer. Further, the order information including the customer-identification-by-display information can be displayed on the display device for checkout processing. Therefore, since the store staff can confirm the information displayed on the display device for checkout processing and the labels affixed to the beverage containers of the products ordered by customers, it is possible to reduce the burden on the store staff when they are providing the products ordered by customers.

Further, since the customer-identification-by-display information can be acquired from the store server 50, there is no need to for the customers to enter their customer-identification-by-display information at the time of placing their orders. Accordingly, it is possible to reduce the burden on the store staff when they are providing the products ordered by customers without putting any burden on the customers when they are placing their orders.

### Fourth Example Embodiment

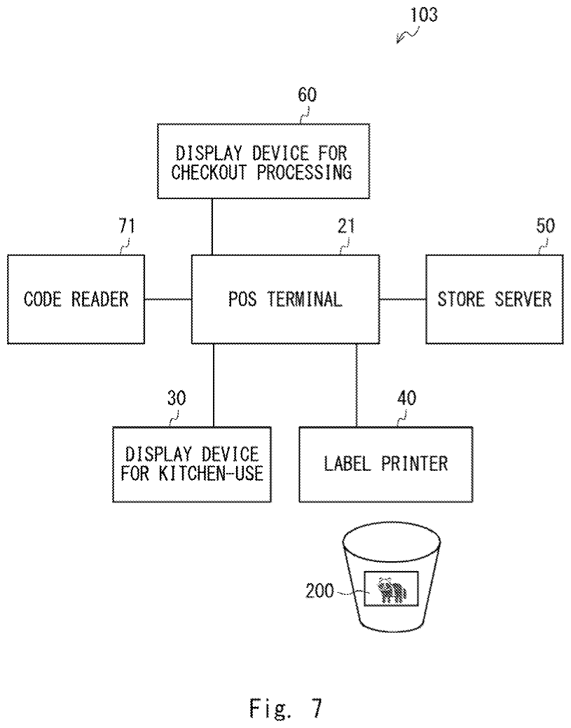

Next, an ordering system 103 according this example embodiment with reference to FIGS. 7 to 9. In this example embodiment, the ordering system 102 described in the third example embodiment will be described in detail.

First, the configuration of the ordering system 103 according to this example embodiment will be described with reference to FIG. 7. FIG. 7 is a block diagram showing a configuration of the ordering system 103. As shown in FIG. 7, the ordering system 103 includes a code reader 71, the POS terminal 21, the label printer 40, the display device for kitchen-use 30, the display device for checkout processing 60, and the store server 50.

The ordering system 103 according to this example embodiment differs from the ordering system 101 according to the second example embodiment in that it includes the store server 50 and the code reader 71 in place the pen tablet 11.

The store server 50 has a customer information table in which the name, the customer identification information 300, the customer-identification-by-display information 200, contact information, point, and the like are stored. The customer identification information 300 is information for uniquely identifying customers such as the customers' membership numbers and an example thereof is a character string of numbers, alphabets, and the like. The customer identification information 300 is assigned for each customer in advance by each customer registering his/her name and the like on the membership website. Further, the customer identification information 300 may be assigned to each membership card and the like issued by the store for each customer.

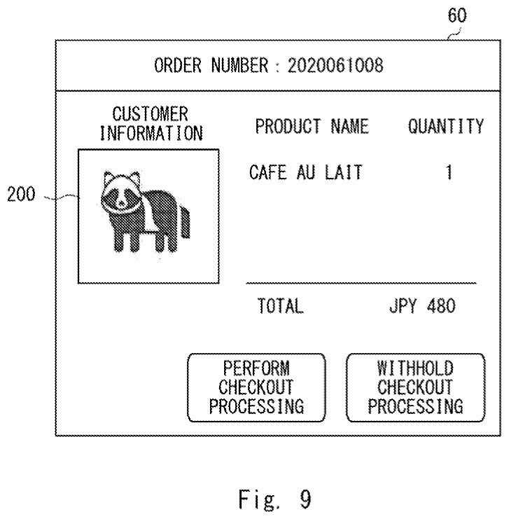

The customer-identification-by-display information 200 includes graphics and pictorial patterns selected by a customer. The customer-identification-by-display information 200 is, for example, an icon to be shown as the “customer information” like the one shown in FIG. 9. The customer-identification-by-display information 200 may not be limited to an icon and may be signatures of a customer like the one described in the second example embodiment.

The store server 50 stores the customer identification information 300 for identifying a customer and the customer-identification-by-display information 200 that is used to identify the customer through display thereof in association with each other.

The code reader 71 is a reader for reading the customer identification information 300 from a medium shown by a customer. The code reader 71 is a one-dimensional barcode reader, a two-dimensional barcode reader, an IC card reader, a magnetic card reader, or the like. The code reader 71 reads the membership number serving as the customer identification information 300 from a barcode printed on a membership card shown by the customer. Further, the code reader 71 may read the barcode displayed on the display screen of a mobile terminal carried by the customer. Since the code reader 71 reads the customer identification information 300 by being brought close to the medium shown by the customer, it is desirable that the code reader 71 be installed at a location near the POS terminal 21. Further, the customer himself/herself may use the code reader 71 to read the customer identification information 300.

The POS terminal 21 is connected to the store server 50 and the code reader 71 through cables or wirelessly in a communicable manner.

The POS terminal 21 acquires, from the store server 50, the customer-identification-by-display information 200 associated with the customer identification information 300 read by the code reader 71 and associates the acquired customer-identification-by-display information 200 with the product ordered by the customer, to thereby acquire the associated information as order information.

Further, the POS terminal 21 generates printing information for printing the customer-identification-by-display information 200 on a label and outputs the generated printing information to the label printer 40.

Further, the POS terminal 21 generates the display information for checkout processing for displaying the order information to the store staff who is performing the checkout operation for the ordered product and outputs the generated display information to the display device for checkout processing 60.

Explanations of the configurations other than those described above are omitted since they the same as those of the second example embodiment.

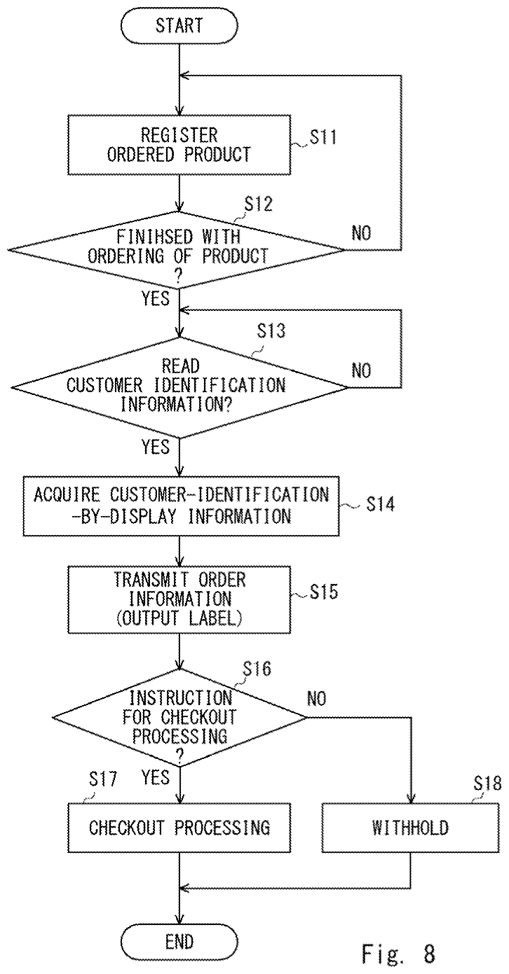

Next, the processing performed by the POS terminal 21 will be described with reference to FIG. 8. FIG. 8 is a flowchart showing processing performed by the POS terminal 21.

First, when a new order is places by a customer, the POS terminal 21 registers the ordered product (Step S11). Next, the POS terminal 21 determines whether or not there has been entry of product order completion (Step S12). In the case where the product order completion has been entered (YES in Step S12), performs the processing of Step S13, and in the case where the product order completion has not been entered (NO in Step S12), the POS terminal 21 returns to Step S11 and repeats the processing of Step S11.

Next, the POS terminal 21 determines whether or not the customer identification information 300 such as the membership number and the like is read by the code reader 71 (Step S13). In the case the customer identification information 300 is read by the code reader 71 (YES in Step S13), the POS terminal 21 performs the processing of Step S14. In the case where the customer identification information 300 is not read by the code reader 71 (NO in Step S13), the POS terminal 21 performs the processing of Step S13. The store staff prompts the customer to show a membership card, a mobile terminal, or the like in order to read the customer identification information 300, and the customer allows the code reader 71 to read the customer identification information 300.

The POS terminal 21 transmits the customer identification information 300 read by the code reader 71 to the store server 50 and acquires the customer-identification-by-display information 200 corresponding to the customer identification information 300 (Step S14). FIG. 9 shows an example of information displayed on the display device for checkout processing 60, the information being the acquired customer-identification-by-display information 200. The order number, the product ordered by a customer, and an icon which is the customer-identification-by-display information 200 are displayed on the display device for checkout processing 60 in association with one another. These displayed information are also displayed on the display device for customer use (not shown) of the POS terminal 21 except for information that is not necessary for the customer such as the checkout button. The POS terminal 21 stores the order number, the product ordered by a customer, and the customer-identification-by-display information 200 as order information.

The POS terminal 21 sends the order information to the display device for kitchen-use 30 and causes the label printer 40 to output a label on which the customer-identification-by-display information 200 is printed and then performs the processing of Step S16 (Step S15). The display device for kitchen-use 30 displays, like the display device for checkout processing 60 shown in FIG. 9, the order information including the customer-identification-by-display information 200.

A store staff in the kitchen confirms the information displayed on the display device for kitchen-use 30, pours the beverage which is the product ordered by a customer into a beverage container (such as a paper cup, a plastic cup, etc.) and affixes the label on which the customer-identification-by-display information 200 is printed to the beverage container.

The POS terminal 21 determines whether or not there has been an input instructing to proceed to checkout processing for the product ordered by a customer (Step S16). In the case an instruction to perform checkout processing for the product ordered by a customer is input (YES in Step S16), the POS terminal 21 performs the processing of Step S17. In the case where an instruction to perform checkout processing for the product ordered by a customer has not been input, that is, in the case where there has been an input to withhold the checkout processing (NO in Step S16), the POS terminal 21 performs the processing of Step S18. In the case where it takes time to provide the product ordered by a customer, the store staff presses a “withhold checkout processing” button like the one shown in FIG. 9 and the checkout processing for the ordered product is withheld.

In the case of performing the checkout processing for the product ordered by a customer (YES in Step S16), the POS terminal 21 performs the necessary checkout processing (Step S17) and the processing ends. At this time, the store staff visually confirms the information displayed on the display device for checkout processing 60 and confirms the label affixed to a beverage container, and then provides the ordered product to a customer. The customer confirms that the provided product is the one he/she ordered by checking the label on the beverage container and then receives the product.

In the case of withholding the checkout processing for a product ordered by a customer (NO in Step S16), the POS terminal 21 does not perform the checkout processing (Step S18) and the processing ends. The order information for which checkout processing has been withheld is called up by store staff upon completion of preparation of the ordered product. Then, the POS terminal 21 performs the checkout processing (Step S17) and the processing ends.

As described above, in the ordering system 103 according to this example embodiment, since the customer-identification-by-display information 200 and the customer identification information 300 are stored in association with each other in the store server 50 in advance, there is no need for the customer to enter the customer-identification-by-display information 200 at the time of placing an order. By this configuration, it is possible to reduce the burden on the store staff when they are providing the products ordered by customers without putting any burden on the customers when they are placing their orders. Further, since icons and the like can be registered in advance, greater freedom of expression can be allowed for the customer-identification-by-display information 200 compared to the case where the customer-identification-by-display information 200 is input through the pen tablet 11 at the time when customers place their orders. For example, it is possible to reduce the possibility of the customer-identification-by-display information 200 being similar to one another at first sight compared to signatures of freehand input. By this configuration, it is possible to prevent accidental receipt of a product ordered by another customer.

<Example of Hardware Configuration>

The functions of the POS terminal 21 and the pen tablet 11 may each be realized in a hardware (e.g. a hard-wired electronic circuit) for implementing the functions or may be realized by a combination of a hardware and a software (e.g. a combination of an electronic circuit and a program for controlling the electronic circuit). Hereinbelow, a case in which the functions of the POS terminal 21 and the like are realized by a combination of a hardware and a software will be further described.

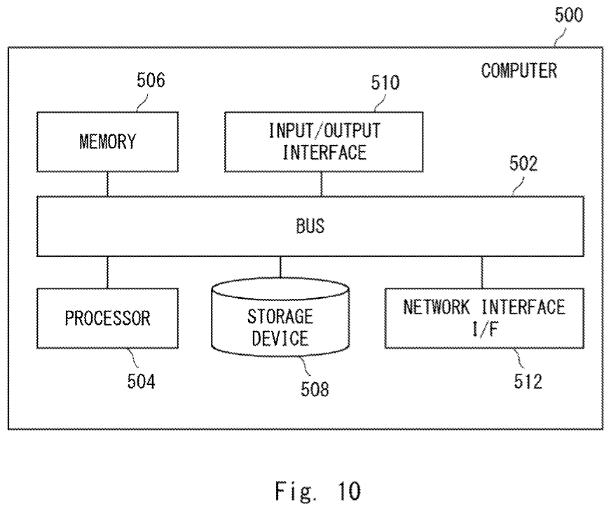

FIG. 10 is a block diagram showing an example of a hardware configuration of a computer 500 realizing the POS terminal 21 and the like. The computer 500 may be a computer designed exclusively for realizing the POS terminal 21 and the like or may be a general-purpose computer.

For example, the functions of the POS terminal 21 and the like can be realized in a computer 500 by installing predetermined applications on the computer 500. The aforementioned applications are configured of programs for realizing the functions of the POS terminal 21 and the like.

The computer 500 includes a bus 502, a processor 504, a memory 506, a storage device 508, an input/output interface 510, and a network interface 512. The bus 502 is a data transmission path for transmitting and receiving data from each other among the processor 504, the memory 506, the storage device 508, the input/output interface 510, and the network interface 512. It is to be noted that the method of connecting the processor 504 and the like with one another is not limited to a bus connection.

The processor 504 may be any processor such as a CPU (Central Processing Unit), a GPU (Graphics Processing Unit), or a FPGA (Field-Programmable Gate Array). The memory 506 is a main storage device that is realized using a RAM (Random Access Memory). The storage device 508 is an auxiliary storage device that is realized using a hard disk, a SSD (Solid State Drive), a memory card, or a ROM (Read Only Memory).

The input/output interface 510 is an interface for connecting the computer 500 and the input/output device. For example, an input device such as a keyboard and an output device such as a display device are connected to the input/output interface 510.

The network interface 512 is an interface for connecting the computer 500 to a network. This network may a LAN (Local Area Network) or a WAN (Wide Area Network).

The storage device 508 stores a program for realizing the functions of the POS terminal 21 and the like (a program for implementing the aforementioned applications). The processor 504 realizes the functions of the POS terminal 21 and the like by reading out the program from the memory 506.

Each processor executes one or a plurality of programs in the instruction group for causing a computer to execute the algorithm. The program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc (registered trademark) or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments, and can be appropriately changed without departing from the spirit of the present disclosure. For example, in the aforementioned example embodiments, the display device for kitchen-use 30 is installed as a kitchen terminal device and the order information including the customer-identification-by-display information 200 is displayed on the kitchen terminal device, but the system configuration is not limited thereto. A printer for kitchen-use may be installed in the kitchen and the order information including the customer-identification-by-display information 200 may be printed from this printer.

The whole or part of the example embodiments disclosed above can be described as, but not limited to, the following supplementary notes.

(Supplementary Note 1)

An ordering system comprising:
a tablet configured to accept input of customer-identification-by-display information that is used to identify a customer through display thereof; and
a control apparatus configured to associate the customer-identification-by-display information that has been input in the tablet with a product ordered by the customer to thereby acquire the associated information as order information,
wherein the control apparatus
   generates printing information for printing the customer-identification-by-display information on a label and outputs the generated printing information to a printer, and
   generates display information for checkout processing for showing the order information to a user who is performing a checkout operation for the product ordered by the customer and outputs the generated display information to a display device for checkout processing.

(Supplementary Note 2)

An ordering system comprising:
a store server configured to store customer identification information for identifying a customer and customer-identification-by-display information that is used to identify the customer through display thereof in association with each other;
a reader for reading the customer identification information from a medium shown by the customer; and
a control apparatus configured to acquire the customer-identification-by-display information associated with the customer identification information read by the reader and associate the acquired customer-identification-by-display information with a product ordered by the customer, to thereby acquire the associated information as order information,
wherein the control apparatus
   generates printing information for printing the customer-identification-by-display information on a label and outputs the generated printing information to a printer, and
   generates display information for checkout processing for showing the order information to a user who is performing a checkout operation for the product ordered by the customer and outputs the generated display information to a display device for checkout processing.

(Supplementary Note 3)

The ordering system described in Supplementary Note 1 or 2, wherein the control apparatus is a POS terminal that performs the checkout processing for the product ordered by the customer.

(Supplementary Note 4)

The ordering system described in any one of Supplementary Notes 1 to 3, wherein the customer-identification-by-display information is tracking information of touch input performed by the customer.

(Supplementary Note 5)

The ordering system described in any one of Supplementary Notes 1 to 4, wherein the control apparatus further generates display information for kitchen-use for displaying the order information in a kitchen and outputs the generated display information to a display device for kitchen-use.

(Supplementary Note 6)

The ordering system described in any one of Supplementary Notes 1 to 5, wherein the control apparatus associates status information indicating status of provision of the product ordered by the customer with the order information to thereby generate the display information for checkout processing.

(Supplementary Note 7)

A control apparatus comprising:
acquisition means for acquiring information obtained by associating customer-identification-by-display information that has been input in a tablet configured to accept input of the customer-identification-by-display information that is used to identify a customer through display thereof with a product ordered by the customer as order information;
output means for generating printing information for printing the customer-identification-by-display information on a label and outputting the generated printing information to a printer; and
output means for generating display information for checkout processing for showing the order information to a user who is performing a checkout operation for the product ordered by the customer and outputting the generated display information to a display device for checkout processing.

(Supplementary Note 8)

A control apparatus comprising:
acquisition means for acquiring, from a store server configured to store customer identification information for identifying a customer and customer-identification-by-display information that is used to identify the customer through display thereof in association with each other, the customer-identification-by-display information associated with the customer identification information being read from a medium shown by the customer and associating the acquired customer-identification-by-display information with a product ordered by the customer, to thereby acquire the associated information as order information;
output means for generating printing information for printing the customer-identification-by-display information on a label and outputting the generated printing information to a printer; and
output means for generating display information for checkout processing for showing the order information to a user who is performing a checkout operation for the product ordered by the customer and outputting the generated display information to a display device for checkout processing.

(Supplementary Note 9)

The control apparatus described in Supplementary Note 7 or 8, wherein the control apparatus is a POS terminal that performs the checkout processing for the product ordered by the customer.

(Supplementary Note 10)

The control apparatus described in any one of Supplementary Notes 7 to 9, wherein the customer-identification-by-display information is tracking information of touch input performed by the customer.

(Supplementary Note 11)

The control apparatus described in any one of Supplementary Notes 7 to 10, further comprising generating means for generating display information for kitchen-use for displaying the order information in the kitchen and output means for outputting the generated display information to a display device for kitchen-use.

(Supplementary Note 12)

The control apparatus according to any one of Supplementary Notes 7 to 11, wherein the display information for checkout processing is generated by associating status information indicating status of provision of the product ordered by the customer with the order information.

(Supplementary Note 13)

A tablet comprising:
display means for displaying an input screen prompting input of customer-identification-by-display information to be printed on a label affixed to a product ordered by a customer;
acquisition means for acquiring the customer-identification-by-display information that has been input in the input screen; and
output means for outputting the acquired customer-identification-by-display information to a control apparatus.

(Supplementary Note 14)

The tablet described in Supplementary Note 13, wherein the control apparatus is a POS terminal that performs the checkout processing for the product ordered by a customer.

(Supplementary Note 15)

The tablet described in Supplementary Note 13 or 14, wherein the customer-identification-by-display information is tracking information of touch input performed by the customer.

(Supplementary Note 16)

A control method comprising steps of:
accepting input of customer-identification-by-display information that is used to identify a customer through display thereof;
acquiring information obtained by associating the customer-identification-by-display information that has been input with a product ordered by the customer as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

(Supplementary Note 17)

A control method comprising steps of:
storing customer identification information for identifying a customer and customer-identification-by-display information that is used to identify the customer through display thereof in association with each other;
reading the customer identification information from a medium shown by the customer;
acquiring the customer-identification-by-display information associated with the customer identification information that has been read in the reading step and associating the acquired customer-identification-by-display information with a product ordered by the customer, to thereby acquire the associated information as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

(Supplementary Note 18)

The control method described in Supplementary Note 16 or 17, wherein the customer-identification-by-display information is tracking information of touch input performed by the customer.

(Supplementary Note 19)

The control method described in any one of Supplementary Notes 16 to 18, further comprising a step of generating display information for kitchen-use for displaying the order information in the kitchen and outputting the generated display information to a display device for kitchen-use.

(Supplementary Note 20)

The control method described in any one of Supplementary Notes 16 to 19, further comprising a step of associating status information indicating status of provision of the product ordered by the customer with the order information to thereby generate the display information for checkout processing.

(Supplementary Note 21)

A control method comprising:
acquiring information obtained by associating customer-identification-by-display information that has been input in a tablet configured to accept input of the customer-identification-by-display information that is used to identify a customer through display thereof with a product ordered by the customer as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

(Supplementary Note 22)

A control method comprising steps of:
acquiring, from a store server configured to store customer identification information for identifying a customer and customer-identification-by-display information that is used to identify the customer through display thereof in association with each other, the customer-identification-by-display information associated with the customer identification information being read from a medium shown by the customer and associating the acquired customer-identification-by-display information with a product ordered by the customer, to thereby obtain the associated information as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

(Supplementary Note 23)

The control method described in Supplementary Note 21 or 22, wherein the checkout processing for the product ordered by the customer is performed by a POS terminal.

(Supplementary Note 24)

The control method described in any one of Supplementary Notes 21 to 23, wherein the customer-identification-by-display information is tracking information of touch input performed by the customer.

(Supplementary Note 25)

The control method described in any one of Supplementary Notes 21 to 24, further comprising a step of generating display information for kitchen-use for displaying the order information in the kitchen and outputting the generated display information to a display device for kitchen-use.

(Supplementary Note 26)

The control method described in any one of Supplementary Notes 21 to 25, further comprising a step of associating status information indicating status of provision of the product ordered by the customer with the order information to thereby generate the display information for checkout processing.

(Supplementary Note 27)

A control program for causing a computer to execute a control method comprising steps of:
acquiring information obtained by associating customer-identification-by-display information that has been input in a tablet configured to accept input of the customer-identification-by-display information that is used to identify a customer through display thereof with a product ordered by the customer as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

(Supplementary Note 28)

A control program for causing a computer to execute a control method that comprises steps of:
acquiring, from a store server configured to store customer identification information for identifying a customer and customer-identification-by-display information that is used to identify the customer through display thereof in association with each other, the customer-identification-by-display information associated with the customer identification information being read from a medium shown by the customer and associating the acquired customer-identification-by-display information with a product ordered by the customer, to thereby obtain the associated information as order information;
generating printing information for printing the customer-identification-by-display information on a label and outputting the generated printing information to a printer; and
generating display information for checkout processing for showing the order information to a user who is performing a checkout operation for the product ordered by the customer and outputting the generated display information to a display device for checkout processing.

(Supplementary Note 29)

The control program described in Supplementary Note 27 or 28, wherein the control method is performed by a POS terminal configured to perform the checkout processing for the product ordered by the customer.

(Supplementary Note 30)

The control program described in any one of Supplementary Notes 27 to 29, wherein the customer-identification-by-display information is tracking information of touch input performed by the customer.

(Supplementary Note 31)

The control program described in any one of Supplementary Notes 27 to for causing a computer to execute a further step of generating display information for kitchen-use for displaying the order information in the kitchen and outputting the generated display information to a display device for kitchen-use.

(Supplementary Note 32)

The control program described in any one of Supplementary Notes 27 to 31 for causing a computer to execute a further step of associating status information indicating status of provision of the product ordered by the customer with the order information to thereby generate the display information for checkout processing.

The present disclosure has been described above with reference to the example embodiments but it is not to be limited to any one of them. The configuration and the details of the present disclosure can be changed in various ways within the scope of the present disclosure that can be understood by a person skilled in the art.

This application is based upon and claims the benefit of priority from Japanese patent application No. 2020-128030, filed on Jul. 29, 2020, the entire contents of which are incorporated herein by reference.

### REFERENCE SIGNS LIST

10 TABLET
11 PEN TABLET
20 CONTROL APPARATUS
21 POS TERMINAL
30 DISPLAY DEVICE FOR KITCHEN-USE
40 LABEL PRINTER
50 STORE SERVER
60 DISPLAY DEVICE FOR CHECKOUT PROCESSING
70 READER
71 CODE READER
100-103 ORDERING SYSTEM

What is claimed is:

1. (canceled)

2. An ordering system comprising:
a store server configured to store customer identification information for identifying a customer and customer-identification-by-display information that is used to identify the customer through display thereof in association with each other;
a reader for reading the customer identification information from a medium shown by the customer; and
a control apparatus configured to acquire the customer-identification-by-display information associated with the customer identification information read by the reader and associate the acquired customer-identification-by-display information with a product ordered by the customer, to thereby acquire the associated information as order information,
wherein the control apparatus
generates printing information for printing the customer-identification-by-display information on a label and outputs the generated printing information to a printer, and
generates display information for checkout processing for showing the order information to a user who is performing a checkout operation for the product ordered by the customer and outputs the generated display information to a display device for checkout processing.

3. The ordering system according to claim 2, wherein the control apparatus is a POS terminal that performs the checkout processing for the product ordered by the customer.

4. The ordering system according to claim 2, wherein the customer-identification-by-display information is tracking information of touch input performed by the customer.

5. The ordering system according to claim 2, wherein the control apparatus further generates display information for kitchen-use for displaying the order information in a kitchen and outputs the generated display information to a display device for kitchen-use.

6. The ordering system according to claim 2, wherein the control apparatus associates status information indicating status of provision of the product ordered by the customer with the order information to thereby generate the display information for checkout processing.

7.-10. (canceled)

11. An information processing apparatus comprising:
at least one memory storing instructions, and
at least one processor configured to execute the instructions to;
associate customer identification information on a customer who has ordered a product with the product ordered by the customer and acquire the associated information as order information;
output printing information for printing the customer identification information on a label; and
output display information including the order information to a display.

12. The information processing apparatus according to claim 11, wherein the display information is output to a display for a store staff.

13. An information processing method, wherein
an information processing apparatus associates customer identification information on a customer who has ordered a product with the product ordered by the customer and acquires the associated information as order information,
the information processing apparatus outputs printing information for printing the customer identification information on a label, and
the information processing apparatus outputs display information including the order information to a display.

14. The information processing method according to claim 13, wherein the display information is output to a display for a store staff.
